(19) United States
(12) Patent Application Publication
(10) Pub. No.: US 2012/0006871 A1
(43) Pub. Date: Jan. 12, 2012

(54) DEVICE FOR HOLDING FOOD ITEMS WHILE BEING TRANSPORTED IN A MOTOR VEHICLE

(76) Inventor: RONALD STROHECKER, Erial, NJ (US)

(21) Appl. No.: 13/179,361

(22) Filed: Jul. 8, 2011

Related U.S. Application Data
(60) Provisional application No. 61/362,401, filed on Jul. 8, 2010.

(51) Int. Cl. B60R 11/00

(52) U.S. Cl. 224/275

(57) ABSTRACT

A device for holding food items while being transported in a motor vehicle having a seat with a seat belt. The device comprises a base member. A non-slip tray is positioned upon the base member. A mechanism is for enabling angle adjustment of the non-slip tray on the base member, so as to keep the food items placed upon the non-slip tray in a level position. The mechanism can be manual or automatic. Another mechanism is for securing the base member in a stationary manner on the seat of the motor vehicle with the seat belt.

### CROSS-REFERENCE TO RELATED APPLICATION

This application claims the benefit of Provisional Patent Application No. 61/362,401, filed on Jul. 8, 2010, in the United States Patent & Trademark Office, the disclosure of which is incorporated herein by reference.

### BACKGROUND OF THE INVENTION

1. Field of the Invention

The present invention relates to an article carrier for a car seat, and more particularly, a device for holding food items while being transported in a motor vehicle.

The present invention includes a tray designed to assist in the transportation of food. The device is secured inside the motor vehicle to hold pizza boxes, cakes, catered food items, salad bowls, and more. The present invention is ideal for use by delivery persons, but can also be used by anyone transporting food to an event or other location. The device prevents spillage by keeping the food level throughout the drive.

2. Description of the Prior Art

When transporting food, such as pizza, it can be difficult to stabilize the food item. Placing the food on the seat of a motor vehicle can cause the item to slide around while in transit. Often times, the food spills inside the motor vehicle and creates a mess. Other times, once the food is delivered to a location, it is discovered that a cake is damaged or a pizza is smashed. A more efficient transportation method is needed.

Numerous innovations for article transportation apparatuses have been provided in the prior art that will be described. Even though these innovations may be suitable for the specific individual purposes to which they address, however, they differ from the present invention.

A FIRST EXAMPLE, U.S. Pat. No. 2,986,438, Issued on May 30, 1961, to Smathers et al. teaches an automobile service table comprising a table top, a pair of similar foldable leg assemblies comprising links having upper ends pivoted to the table top adjacent to related ends thereof, the links having lower ends, inverted U-shaped forms having bight portions, the bight portions having single upstanding locking arms thereon, a single detent bar fixed to the table top and extending between the ends of the table top, and detent means comprising a plurality of detent elements spaced along the detent bar and detent members on the locking arms which are selectively engageable with detent elements of the detent bar.

A SECOND EXAMPLE, U.S. Pat. No. 3,318,456, Issued on May 9, 1967, to Lipe teaches a car seat tray comprising a substantially planar surface having lateral edges and forming at least one aperture for the reception of a cup; depending spaced apart support means for holding the planar surface substantially horizontal on a bench type automobile seat, the support means comprising two spaced apart elongated planar support members, each having a substantially straight upper edge and a concave lower edge configured to conform to a cross section of the upper surface of a bench type car seat taken longitudinally of a car, and means connecting each of the support members to the planar surface adjacent the lateral edges, the support members being integral with and forming a continuation of the planar surface.

A THIRD EXAMPLE, U.S. Pat. No. 5,307,968, Issued on May 3, 1994, to Kalmbach teaches a tray for use on the passenger seat of a motor vehicle. The tray has a tray base which rests on the passenger seat and has one or more compartments for holding articles in a manner which is accessible to the motor vehicle driver. At least one sponge-like member is held to the edge of the tray which is next to the passenger door. The tray is secured to the passenger seat by opening the passenger door, allowing the resilient member to rest against the side of the passenger seat and then slamming the passenger seat door to compress the resilient member and hold the tray on the seat.

A FOURTH EXAMPLE, U.S. Pat. No. 5,470,002, Issued on Nov. 28, 1995, to DiStefano et al. teaches a self-leveling food container device which consists of a food carrying case sized to accommodate food therein. An integral mechanism is provided with the carrying case for automatic leveling when placed on a motor vehicle seat, so as to prevent the food within the carrying case from sliding and spilling while being transported. Insulated walls are provided to maintain food temperatures. Heating coils within the insulated walls allow warming of food during transport. An inflatable air bladder provides both the leveling mechanism and a vibration isolation function.

A FIFTH EXAMPLE, U.S. Pat. No. 5,611,287, Issued on Mar. 18, 1997, to Begley teaches a levelling device formed from a single sheet of foldable material which is used to convert an automobile seat into a flat, horizontal surface. More particularly, the levelling device comprises front and rear straight edges, two side edges each configured in the form of stretched “Z” and at least one scored line parallel to the rear straight edge such that the scored line can be folded downward to form a support leg. In a preferred embodiment, the levelling device further comprises a locking mechanism comprising a secondary scored line, two die cuts which intersect the primary scored line and a third die cut which is parallel to the secondary scored line, the locking mechanism being pressed downward to form a die cut finger, wherein the finger is used to keep the support leg in a secure position.

A SIXTH EXAMPLE, U.S. Pat. No. 5,667,272, Issued on Sep. 16, 1997, to Sutton teaches a platform assembly for use in combination with a vehicle including a vehicle seat having a seat bottom, seat back, and a head rest. The platform assembly is supported by the seat to carry articles for ready access by an occupant of the vehicle. The platform assembly includes a platform defining a flat slip-resistant surface area for supporting articles thereon, and for preventing substantial shifting of the articles while the vehicle is in motion. An adjustable attachment strap is secured to a back end of the platform, and extends upwardly from the platform adjacent to the seat back for removable attachment to the headrest. The attachment strap permits leveling adjustment of the platform, and unobstructed access by the vehicle occupant to the articles supported on the platform.

A SEVENTH EXAMPLE, U.S. Pat. No. 6,015,198, issued on Jan. 18, 2000, to Stair teaches an in-car work station adapted to be supported on a front passenger seat and provide easy access from the driver seat. The work station has an immovable top surface located adjacent to the front of the work station which can be used as a support surface for articles being used by the occupant of vehicle. A drawer is provided in the work station and is laterally extendable from its stored position to a use position where the drawer extends in the inboard direction toward the driver seat thereby increasing access by the driver. The drawer includes a receptacle cavity having a support tray for receiving a note pad thereon and readily permitting access from the driver seat to the note pad.

A EIGHTH EXAMPLE, U.S. Pat. No. 6,426,869, issued on Jul. 30, 2002, to White teaches a portable work station which is designed to be used in motor vehicles. The work station is a cabinet which is capable of being secured to a passenger seat of the motor vehicle, preferably by an attached securing means. There is provided a computer tray which is adapted to be releasable attachable to the work surface of the work station and capable of being received within the interior of the work station. An alternate embodiment of the present invention provides a computer tray which is attached to an articulated cantilever system which, when the lid to the main compartment is opened, projects and presents the computer tray and any computer which is secured thereon.

A NINTH EXAMPLE, U.S. Patent Office Publication No. 2003/0160076, published on Aug. 28, 2003, to Lofaro teaches a carrier device for the simple and secure transportation of objects, in particular flower containers, in a vehicle. As disclosed, the carrier device comprises a plurality of panels which when folded in a specific manner, form a device for securing an object. In addition, the device comprises means for securing itself using a conventional seatbelt of a vehicle.

Consequently, the device prevents the object from moving by holding the top of the object and surrounding the sides of the object. The device itself is then held stationary by placing a conventional seatbelt around the device, positioning the seatbelt in notches located in pre-determined location on the device. The design of the carrier device allows for the object to be some distance from the back of the seat and, as a result, prevent damage to the object.

A TENTH EXAMPLE, U.S. Patent Office Publication No. 2004/0149621, published on Aug. 5, 2004, to Sgrigholi teaches a food and activity tray possessing the ability to accommodate different permutations and sizes of food and beverage packages or containers, wherein the tray further provides a functional work surface and/or activity surface capable of receiving a plurality of interchangeable game faces or plates for entertainment purposes.

AN ELEVENTH EXAMPLE, U.S. Patent Office Publication No. 2004/0232181, published on Nov. 25, 2004, to Marnell teaches a carrying device most specifically for carrying a pizza box in a level position when placed on a car seat which slopes downwardly from the front edge of the car seat toward the back rest. A pair of side panels extend from a back panel and are joined together at the ends of the side panels opposite from the back panel. End flaps are located on the ends of the side panels opposite from the back panel and are elevated above the side panels. Likewise, the back panel extends above the height of the side panels. The side panels have a bottom edge which moves closer to the top edge as the side panels extend from the back panel to the end flaps. A pizza box fits between the back panel and the end flaps. If the carrying device is to be used with boxes of varying sizes, perforations are located in the top edge of the side panels to permit a variety of portions of the top edges of the side panels to be turned down to hold pizza boxes of varying sizes.

A TWELFTH EXAMPLE, U.S. Patent Office Publication No. 2008/0067205, published on Mar. 20, 2008, to Semendoff teaches an article securing device for carrying articles in a vehicle on a vehicle seat includes an adjustable support plate, a first lip extending outwardly from the top surface of the support plate at the front edge thereof, and an adjustable leg extending outwardly from the bottom surface of the support plate at the rear edge thereof. The article securing device further includes a strap which is positionable over the top surface of the support plate to hold articles on the support plate. The article securing device is placed on a car seat, with the leg being situated near the backrest of the car seat and the lip being situated near the front edge of the car seat so that the support plate and any articles resting thereon remain level as the articles are being transported in the vehicle on the vehicle seat.

A THIRTEENTH EXAMPLE, U.S. Patent Office Publication No. 2008/0134945, published on Jun. 12, 2008, to Willey teaches an assembly for supporting at least one item while in transit within a vehicle having cushioned passenger seating. The assembly used during transit within a vehicle, has: a platform (for supporting the item) that has an aperture for receiving at least one primary support-post therethrough, and a plurality of recesses; an anchor for releasably securing the assembly between cushion structures within the vehicle is used (e.g., such that it can be wedged into the spacing between back support cushion and seat cushion). The anchor comprises a base member having a free end and a bulbous end, between which a pedestal extends having a recessed shape, such as a cup, for receiving a lower end of the primary support-post. The bulbous end can be fabricated integral with the base member, or made of one or more hinged-sections interconnected with the base member. At least a portion of the outer surface of the primary support-post is preferably threaded, around which a mating internally-threaded leveling ring can twist. Also, an assembly for supporting at least one item while in transit from location to location, wherein the anchor and primary support-post and leveling ring are not operationally assembled.

A FOURTEENTH EXAMPLE, U.S. Patent Office Publication No. 2008/0223913, published on Sep. 18, 2008, to Nadeau teaches a wedge-shaped support caddy device suitably adapted to be placed on an automobile seat to provide a level surface on which to place objects, while also providing a container for smaller objects.

The support caddy device is constructed of corrugated cardboard for strength, rigidity, durability, and low cost, and can be manufactured from a unitary sheet, thereby allowing for ease of storage until needed for use, when it can be folded into its intended configuration.

A FIFTHTEENTH EXAMPLE, U.S. Pat. No. 7,481,169, issued on Jan. 27, 2009, to Larson teaches an apparatus for leveling an object with respect to a support surface. The apparatus includes a top portion that defines a planar surface. The top portion transitions into or is connected with a base. The base is foldable with respect to the top portion, and a free end portion of the base is removably securable to the top portion at one of a plurality of positions to adjust a height of the base and maintain the planar surface level with respect to the support surface.

A SIXTEENTH EXAMPLE, U.S. Patent Office Publication No. 2010/0147861, published on Jun. 17, 2010, to Andochick teaches a storage tray includes a container having an opening and one or more elastic strips each coupled to the container and traversing the opening of the container. An object placed in the container through the opening is restrained by at least one the elastic strips. The container may be supported by a deformable pad coupled to the underside of the container. Magnetic elements may be use coupled the deformable pad to the container. The storage tray may be used for transporting objects in a vehicle.

A SEVENTEENTH EXAMPLE, U.S. Pat. No. 7,931,188, issued on Apr. 26, 2011, to Marinelli et al. teaches a combination of a pizza box and leveling device for the pizza box. The pizza box has at least one sidewall that is formed having two adjacent panels with a cavity between the adjacent panels, and, a bottom that has at least one slot. The at least one slot is substantially aligned with and provides access to the cavity. And, the leveling device has at least one portion thereof formed for insertion into the at least one slot and further into the cavity of the sidewall of the pizza box so as to detachably attach the leveling device to the pizza box.

It is apparent now that numerous innovations for article transportation apparatuses have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a device for holding food items while being transported in a motor vehicle that avoids the disadvantages of the prior art.

ANOTHER OBJECT of the present invention is to provide a device for holding food items while being transported in a motor vehicle that is simple and inexpensive to manufacture.

STILL ANOTHER OBJECT of the present invention is to provide a device for holding food items while being transported in a motor vehicle that is simple to use.

BRIEFLY STATED, STILL YET ANOTHER OBJECT of the present invention is to provide a device for holding food items while being transported in a motor vehicle having a seat with a seat belt. The device comprises a base member. A non-slip tray is positioned upon the base member. A mechanism is for enabling angle adjustment of the non-slip tray on the base member, so as to keep the food items placed upon the non-slip tray in a level position. Another mechanism is for securing the base member in a stationary manner on the seat of the motor vehicle with the seat belt.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a front left perspective view of a portion of a motor vehicle showing the present invention holding a pizza box on a car seat;

FIG. 2 is a front left perspective view of the present invention per se;

FIG. 3 is a bottom left perspective view taken in the direction of arrow 3 in FIG. 2;

FIG. 4 is a front right perspective view of the present invention per se;

FIG. 5 is a front left perspective view, similar to FIG. 1, showing the present invention holding various food items on the car seat;

FIG. 6 is a top right perspective view taken in the direction of arrow 3 in FIG. 2; and

FIG. 7 is a front left perspective view of the present invention per se.

### REFERENCE NUMERALS UTILIZED IN THE DRAWING

110 device
112 food items
114 motor vehicle
116 seat of motor vehicle 114
118 seat belt of motor vehicle 114
120 base member of device 110
122 non-slip tray of device 110
124 angle adjustment enabling mechanism of device 110
126 securing mechanism of device 110
128 side wall of base member 120
130 front wall of base member 120
132 rear wall of base member 120
134 box-like configuration for base member 120
136 tapered side bumper track of non-slip tray 122
138 underside of non-slip tray 122
140 hinge of angle adjustment enabling mechanism 124
142 pin of hinge 140
144 hand crank assembly of angle adjustment enabling mechanism 124
146 hook of securing mechanism 126
148 slot in side wall 128 of securing mechanism 126
150 bottom edge of side wall 128
152 durable plastic material for base member 120
154 durable plastic material for non-slip tray 122
160 lead screw
160A geartrack on the lead screw 160
160B geartrack on the 12VDC reversible motor 165
165 12VDC reversible motor
190 slider with two slits 190A-190B, and two grooves 192A-192B
195 bubble level indicator

### DETAILED DESCRIPTION OF THE PREFERRED EMBODIMENT

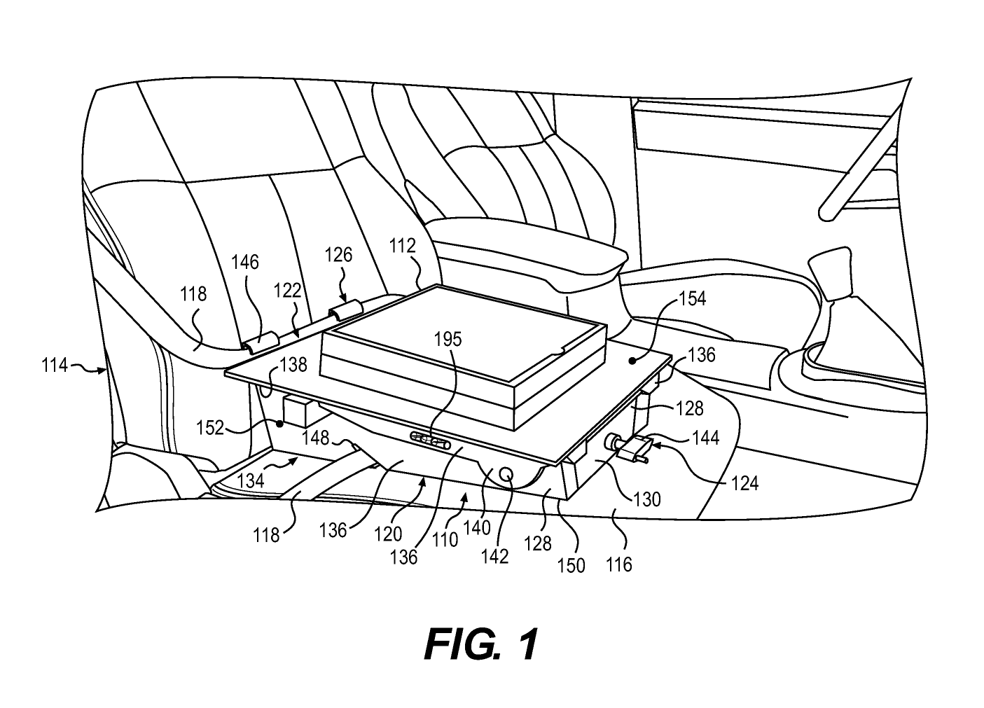

As shown in FIG. 1, the present invention is a device 110 holding food items 112 while being transported in a motor vehicle 114 having a seat 116 with a seat belt 118. The device 110 comprises a base member 120. A non-slip tray 122 is positioned upon the base member 120. A mechanism 124 is for enabling angle adjustment of the non-slip tray 122 on the base member 120, so as to keep the food items 112 placed upon the non-slip tray 122 in a level position. Another mechanism 126 is for securing the base member 120 in a stationary manner on the seat 116 of the motor vehicle 114 with the seat belt 118.

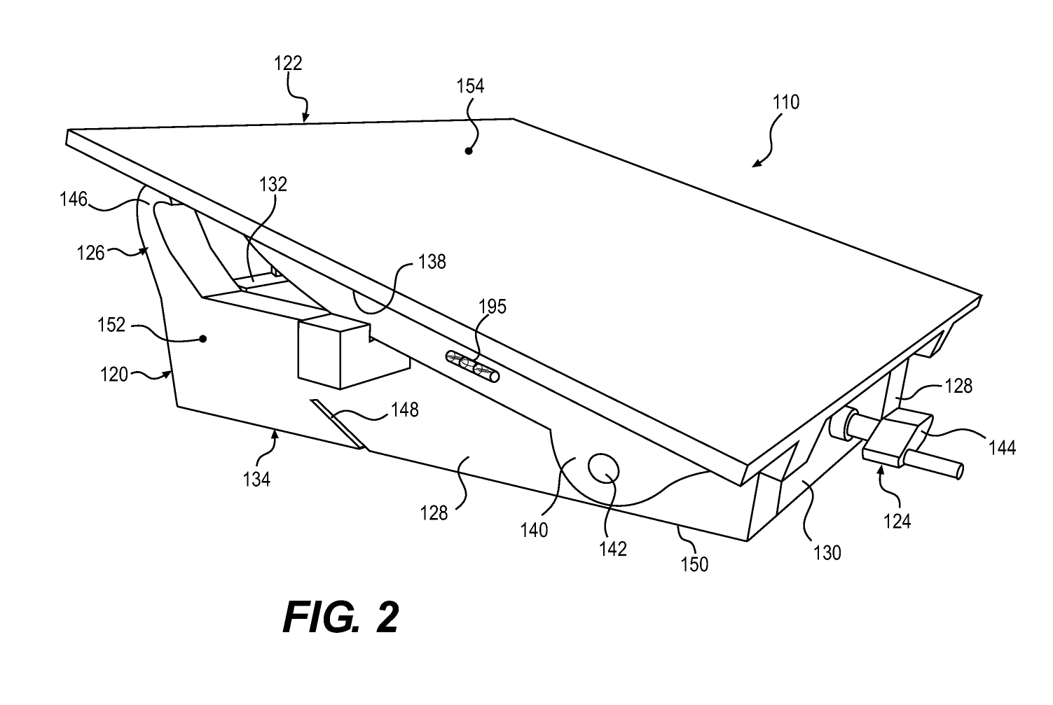

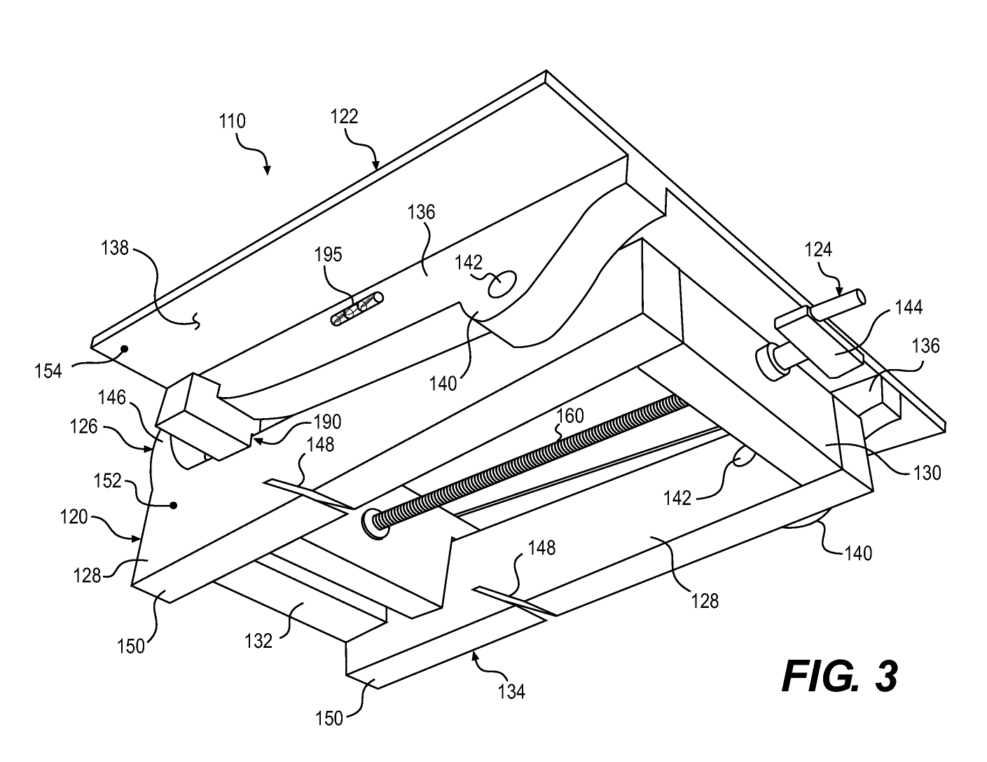

In FIGS. 2-3, the angle adjustment enabling mechanism 124 comprises a pair of hinges 140. Each hinge 140 is formed on a forward portion of one tapered side bumper track 138. Each hinge 140 has a pin 142 that extends into one side wall 128 of the base member 120. A hand crank assembly 144 has a lead screw 160 extends between the front wall 130 and a slider 190 (near the rear wall 132 of the base member 132. The hand crank assembly 144 when manually operated will raise and lower the slider 190 so the slider 190 will raise or lower the tapered side bumper tracks 136 so the slide 190 will change the angle of the non-slip tray 122. The slider 190 has two slits 190A-190B for sliding on side walls 128 and two grooves 192A-192B for supporting two tapered side bumper tracks 136.

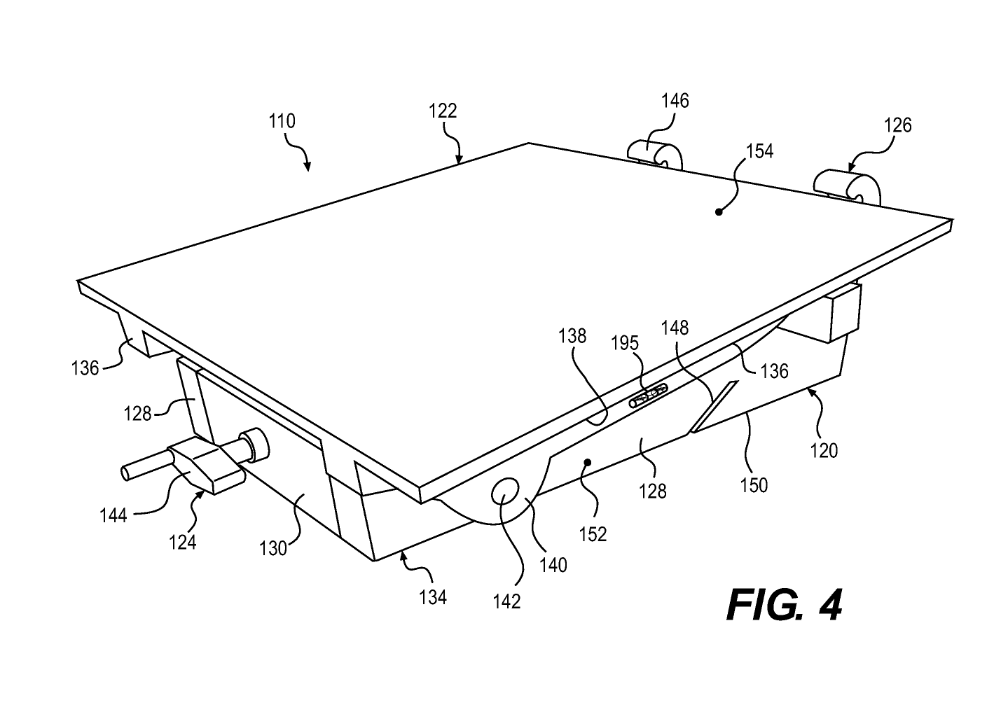

In FIG. 4, the base member 120 comprises a pair of side walls 128, a front wall 130 and a rear wall 132 forming a box-like configuration 134. The non-slip tray 122 comprises a pair of spaced apart tapered side bumper tracks 136 extending downwardly from underside 138 of the non-slip tray 122.

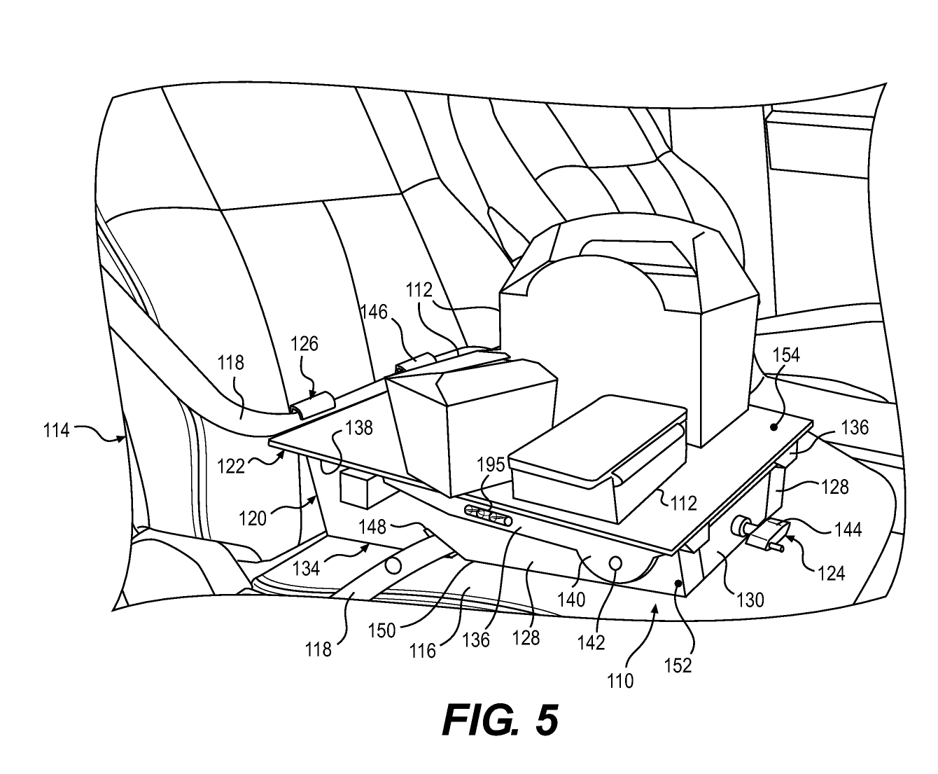

In FIG. 5, the securing mechanism 126 comprises a pair of spaced apart hooks 146 extending upwardly from the rear wall 132 of the base member 120. Each side wall 128 of the base member 120 has a diagonal slot 148 extending in a rearward manner upwardly from a bottom edge 150. The hooks 146 and slots 148 can engage with the seat belt 118 of the motor vehicle 114 when the base member 120 is placed upon the seat 116 and the seat belt 118 is buckled. The base member 120 is comprised out of a durable plastic material 152. The non-slip tray 122 is comprised out of a durable plastic material 154.

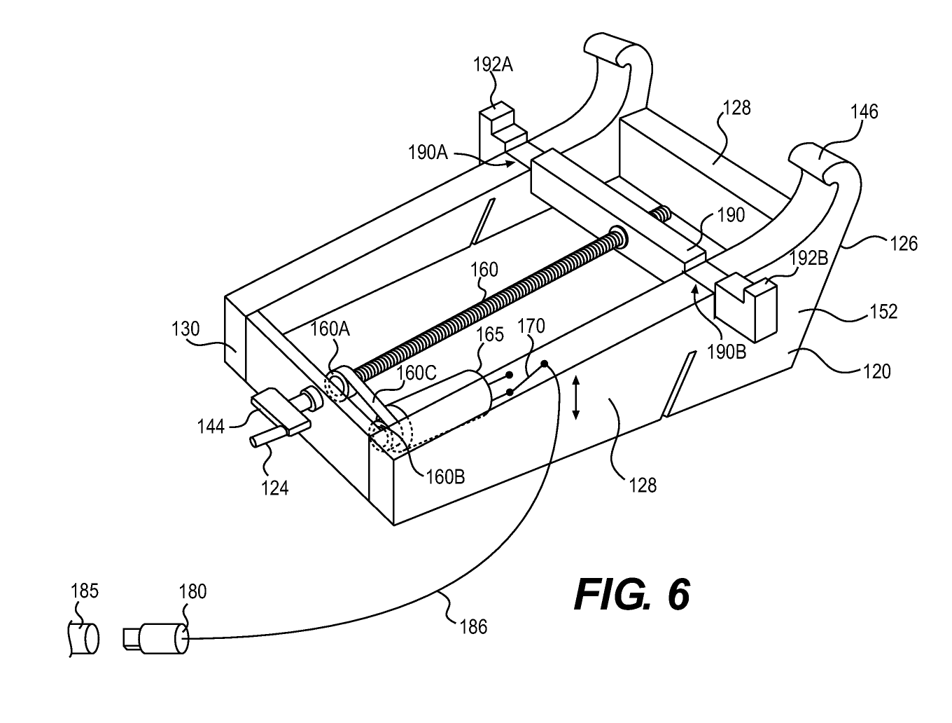

In FIG. 6, an angle adjustment enabling mechanism 124 can be an automatic version. A 12VDC reversible motor 165, a belt 160C and two gear tracks 160A-160B, and up-down switch 170 may be used to adjust the angle of the non-slip tray 122. The 12VDC reversible motor 165 will have an electric cord 186 with plug 180 that may be plugged into an adaptor 185 in the motor vehicle 114. When the switch 170 is down-pressed, the motor 165 is running counter-clockwise leading the lead screw 160 (via geartracks 160A-160B and belt 160C) lowering the slider 190, so the tray 122 is lower. When the switch 170 is up-pressed, the motor 165 is reversibly running clockwise leading the lead screw 160 (via geartracks 160A-160B and belt 160C), so the tray 122 is raised. The geartrack 160B is twice the geartrack 160A. One full rotation of the manual crank or lead screw 160 will lead to 0.5 degree elevation of the non-slip tray 122.

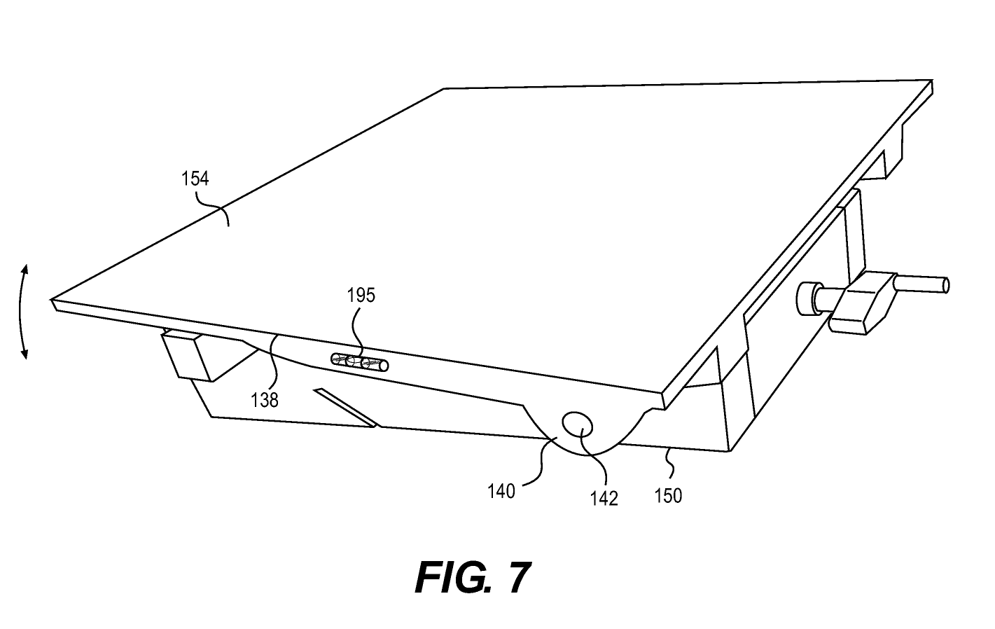

In FIG. 7, a bubble level indicator 195 is on the underside 138 of non-slip tray 122. The length of the device is 15 inches-22 inches.

It will be understood that each of the elements described above, or two or more together, may also find a useful application in other types of constructions differing from the types described above.

While the invention has been illustrated and described as embodiments of a device for holding food items while being transported in a motor vehicle, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A device for holding food items while being transported in a motor vehicle having a seat with a seat belt, the device comprises:
a) a base member;
b) a non-slip tray positioned upon the base member;
c) a bubble level indicator located on a side of the non-slip tray to indicate the level of the tray;
d) means for enabling angle adjustment of the non-slip tray on the base member, so as to keep the food items placed upon the non-slip tray in a level position; and
e) means for securing the base member in a stationary manner on the seat of the motor vehicle with the seat belt.

2. The device as recited in claim 1, wherein the base member comprises a pair of side walls, a front wall and a rear wall forming a box-like configuration.

3. The device as recited in claim 2, wherein the non-slip tray comprises a pair of spaced apart tapered side bumper tracks extending downwardly from underside of the non-slip tray.

4. The device as recited in claim 3, wherein the angle adjustment enabling means comprises:
a) a pair of hinges, whereby each hinge is formed on a forward portion of one tapered side bumper track, each hinge having a pin that extends into one side wall of the base member; and
b) a hand crank assembly has a lead screw extending between the front wall and a slider of the base member, whereby the hand crank assembly when manually operated will raise and lower the slider so the slider will raise or lower the tapered side bumper tracks so the slide will change the angle of the non-slip tray.

5. The device as recited in claim 4, wherein the slider has two slits for sliding on side walls and two grooves for supporting two tapered side bumper tracks.

6. The device as recited in claim 2, wherein the securing means comprises:
a) a pair of spaced apart hooks extending upwardly from the rear wall of the base member; and
b) each side wall of the base member having a diagonal slot extending in a rearward manner upwardly from a bottom edge, whereby the hooks and slots can engage with the seat belt of the motor vehicle when the base member is placed upon the seat and the seat belt is buckled.

6. The device as recited in claim 1, wherein the base member is comprised out of a durable plastic material.

7. The device as recited in claim 1, wherein the non-slip tray is comprised out of a durable plastic material.

8. The device as recited in claim 1, wherein an angle adjustment enabling mechanism can be an automatic version including a 12VDC reversible motor, a belt and two gear tracks, and up-down switch may be used to adjust the angle of the non-slip tray and the geartrack of the motor is twice the geartrack of the lead screw.

9. The device as recited in claim 8, wherein the 12VDC reversible motor will have an electric cord with plug that may be plugged into an adaptor in the motor vehicle.

10. The device as recited in claim 8, wherein when the switch is down-pressed, the motor is running counter-clockwise leading the lead screw (via geartracks and belt) lowering the slider, so the tray is lower. When the switch is up-pressed, the motor is reversibly running clockwise leading the lead screw (via geartracks and belt), so the tray is raised.

11. The device as recited in claim 8, wherein one full rotation of the manual crank or lead screw will lead to 0.5 degree elevation of the non-slip tray.
